(19) United States
(12) Patent Application Publication
(10) Pub. No.: US 2010/0125752 A1
(43) Pub. Date: May 20, 2010

(54) SYSTEM FOR AUTO-OPERATING BACKUP FIRMWARE AND METHOD THEREOF

(75) Inventors: Chih-Wei CHEN, TAIPEI CITY (TW); Hsiao-Fen LU, TAIPEI CITY (TW)

Correspondence Address: BRIAN M. MCINNIS, 12th Floor, Ruttonjee House, 11 Duddell Street, Hong Kong, HK

(73) Assignee: INVENTEC CORPORATION, TAIPEI CITY (TW)

(21) Appl. No.: 12/371,619

(22) Filed: Feb. 15, 2009

(30) Foreign Application Priority Data
Nov. 18, 2008 (TW) 97144525

(51) Int. Cl. G06F 11/08; G06F 11/20

(52) U.S. Cl. 714/6; 714/E11.03; 714/E11.055

(57) ABSTRACT

A system for auto-operating backup firmware I disclosed, which includes a baseboard management controller, a first BIOS ROM, a second BIOS ROM, and an inverter. The baseboard management controller has an I/O pin. The first BIOS ROM is electrically connected to the I/O pin of the baseboard management controller. The inverter is electrically connected to the I/O pin, and the second BIOS ROM is electrically connected to the inverter. A method for auto-operating backup firmware is also disclosed.

### RELATED APPLICATIONS

This application claims priority to Taiwan Application Serial Number 97144525, filed Nov. 18, 2008, which is herein incorporated by reference.

### BACKGROUND

1. Field of Invention

The present invention relates to a system and method for auto-operating backup firmware. More particularly, the present invention relates to a system and method for auto-operating backup BIOS ROM.

2. Description of Related Art

In general computer systems, the Basic Input-Output System (BIOS) program is stored in non-volatile memory such as the Flash ROM, PROM, EPROM, EEPROM, etc., and the BIOS ROM is installed on the motherboard or included in the system chips to permanently store its content without the influence of the power supply. However, errors still inevitably occur in the BIOS ROM. From time to time, the circuit structure degenerates, or due to irregular operations when updating the BIOS or other unexpected operations causing failures or data loss, thus the system is not able to start up when errors occur in running the BIOS program. So it is important to have a BIOS retrieval and backup of a computer system.

In some conventional computer systems, two BIOS memory apparatuses in a computer system or two portions of BIOS data in one BIOS ROM are introduced and switched by software. For switching the BIOS by the software, the content in the initiation section of the BIOS data must be accurate to switch the BIOS to start up a computer otherwise the system will still crash during the start-up procedure if data in the initiation section of the BIOS program has collapsed.

### SUMMARY

The present invention provides a system for auto-operating backup firmware, which includes a baseboard management controller, a first BIOS ROM, a second BIOS ROM, and an inverter. The baseboard management controller has an I/O pin. The first BIOS ROM is electrically connected to the I/O pin of the baseboard management controller. The inverter is electrically. connected to the I/O pin, and the second BIOS ROM is electrically connected to the inverter.

It is to be understood that both the foregoing general description and the following detailed description are by examples, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 is a schematic diagram of an embodiment of the system for auto-operating backup firmware of the invention;

FIG. 2 is a schematic diagram of another embodiment of the system for auto-operating backup firmware of the invention;

FIG. 3 is a flow chart diagram of an embodiment of the method for auto-operating backup firmware of the invention; and

FIG. 4 is a flow chart diagram of another embodiment of the system for auto-operating backup firmware of the invention.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The invention provides a system for auto-operating backup firmware and the method thereof. The system for auto-operating backup firmware has two BIOS ROMs, which can be the backup firmware to each other. The system can auto switch to another BIOS ROM to start up the system when the predetermined BIOS ROM is non-functional.

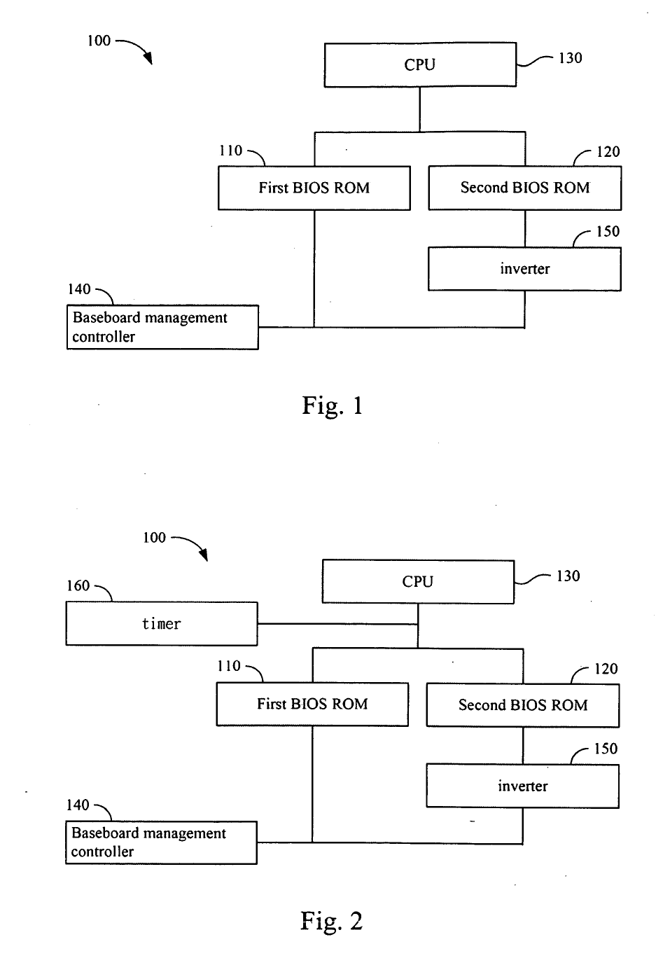

Refer to FIG. 1. FIG. 1 illustrates a schematic diagram of the system for auto-operating backup firmware of the invention. The system 100 includes a first basic input-output system read only memory (BIOS) ROM 110, a second BIOS ROM 120, a central processing unit (CPU) 130, a baseboard management controller (BMC) 140, and an inverter 150.

The first BIOS ROM 110 and the second BIOS ROM 120 are two independent components. The first BIOS ROM 110 and the second BIOS ROM 120 can the backup firmware to each other. The CPU 130 is electrically connected to the first BIOS ROM 110 and the second BIOS ROM 120 respectively. The first BIOS ROM 110 and the second BIOS ROM 120 are electrically connected to an I/O pin of the baseboard management controller 140. The inverter 150 is disposed between the baseboard management controller 140 and the second BIOS ROM 120.

In this embodiment, the first BIOS ROM 110 is regarded as the preferred BIOS ROM for booting the system 110, and the second BIOS ROM 120 is regarded as the backup BIOS ROM. The I/O pin of the baseboard management controller 140 can send a high level signal, which can be regarded as an enable signal when the system is started up normally. The enable signal is sent to the first BIOS ROM 110, and the first BIOS ROM 110 is enabled to boot the system.

The high signal sending to the second BIOS ROM 120 is inverted to a low level signal by the inverter 150, which can be regarded as a disable signal. The disable signal is sent to the second BIOS ROM 120, and the second BIOS ROM 120 would not be operated.

However, if the first BIOS ROM 110 cannot operate normally, the system 100 could not be started up normally or there might be a problem in the POST state, and the system 100 would be restarted. The BIOS ROM to boot the system 100 in the embodiment can be switch to the backup BIOS ROM, i.e. the second BIOS ROM 120 when the system 100 is restarted.

The I/O pin of the baseboard management controller 140 would send a low level signal, which can be regarded as the disable signal when the system 100 is restarted. The disable signal is sent to the first BIOS ROM 110, and the first BIOS ROM 110 would not be operated.

The low level signal send to the second BIOS ROM 120 can be inverted to the high level signal by the inverter 150, which can be regarded as the enable signal. The enable signal inverted by the inverter 150 is further sent to the second BIOS ROM 120, thus the system 100 can be started up by the second BIOS ROM 120.

Refer to FIG. 2. FIG. 2 illustrates another embodiment of the system for auto-operating backup firmware of the invention. The system 100 further includes a timer 160. The timer 160 is electrically connected to the baseboard management controller 140, the first BIOS ROM 110, and the second BIOS ROM 120. The timer 160 is a watchdog timer.

The system 100 can be started up by the first BIOS ROM 110 or the second BIOS ROM 120. The first BIOS ROM 110 or the second BIOS ROM 120 would erase the timer 160 repeatedly when the system 100 is operated normally. However, the counting in the timer 160 would not be erased if the system 100 failed to start up.

The counting in the timer 160 cannot be erased when the system 100 fails to start up. The timer 160 would generate an expiration signal when the count in the timer 160 is larger than a predetermined number, and the expiration signal is sent to the baseboard management controller 140 in the predetermined time, which is corresponding to the predetermined number of the timer 160. The setting of the output setting of the I/O pin of the baseboard management controller 140 is inverted when the baseboard management controller 140 received the expiration signal, thus the output signal of the baseboard management controller 140 would be inverted when the system 100 is restarted, and the system 100 can be booted by the backup BIOS ROM. The baseboard management controller 140 can also send a massage to remind users that one of the BIOS ROM needs to be replaced.

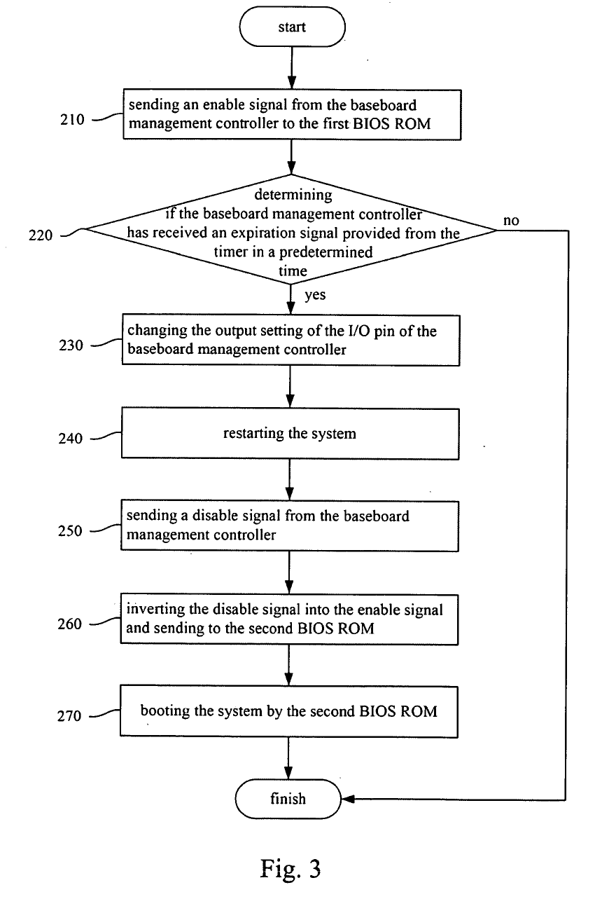

Refer to FIG. 2 and FIG. 3 simultaneously. FIG. 3 illustrates a flow chart diagram of an embodiment of the method for auto-operating backup firmware of the invention. Step 210 is sending an enable signal from the baseboard management controller 140 to the first BIOS ROM 110. The enable signal is sent to the first BIOS ROM 110, and the first BIOS ROM 110 is at an enable state to boot the system 100. The enable signal sending to the second BIOS ROM 120 would be inverted to the disable signal by the inverter 150 and sent to the second BIOS ROM 120, and the second BIOS ROM 120 is at the disable state and would not operate.

Step 220 determines if the baseboard management controller 140 has received the expiration signal provided from the timer 160 in a predetermined time. If the baseboard management controller 140 did not receive the expiration signal, namely, the first BIOS ROM 110 has erased the timer 160 repeatedly, and the system 100 would be regarded as started up normally.

However, if the baseboard management controller 140 has received the expiration signal in step 220, the start-up process has failed. Then, step 230 changes the output setting of the I/O pin of the baseboard management controller 140, thus the output signal of the I/O pin would become a disable signal after the system 100 is restarted.

In Step 240 the system 100 restarts after the baseboard management controller receives the expiration signal. In step 250, the setting of the output signal of the I/O pin of the baseboard management controller 140 has been changed in step 230 and the output signal becomes the disable signal. The disable signal is sent to the first BIOS ROM 110, and the first BIOS ROM 110 would not be operated.

The disable signal sent to the second BIOS ROM 120 is inverted to the enable signal by the inverter 150 and sent to the second BIOS ROM 120 in step 260. The second BIOS ROM 120 is at the enable state, and the system 100 is booted by the second BIOS ROM 120 in step 270. The timer 160 can be erased after the system 100 is restarted by the second BIOS ROM 120 successfully.

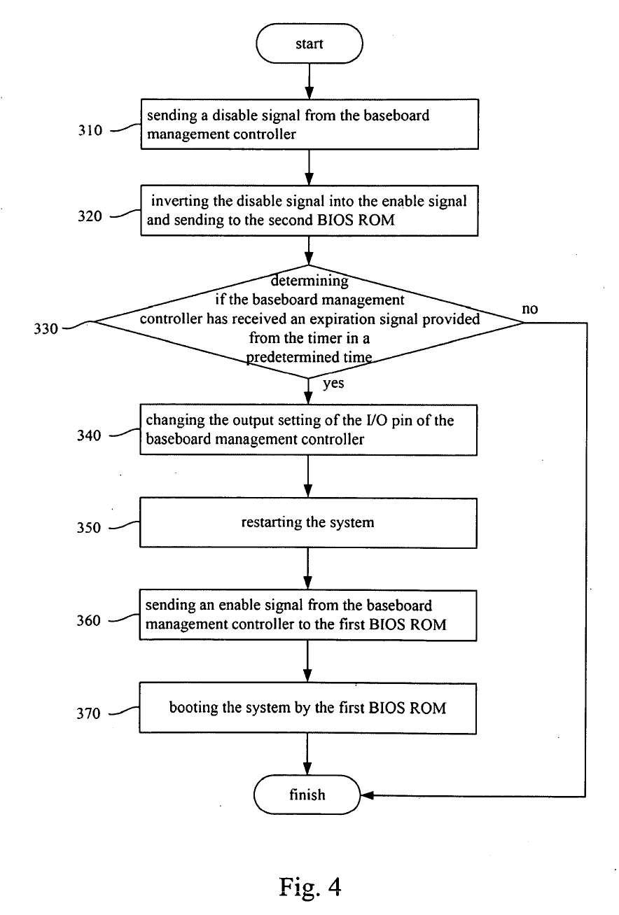

Refer to FIG. 2 and FIG. 4. FIG. 4 illustrates another embodiment of the method for auto*operating backup firmware of the invention. The second BIOS ROM 120 is regarded as the preferred BIOS ROM for booting the system 100, and the first BIOS ROM 110 is regarded as the backup BIOS ROM in this embodiment.

In step 310, the output signal of the baseboard management controller 140 is the disable signal. The disable signal is sent to the first BIOS ROM 110, and the first BIOS ROM 110 is at the disable state and would not operate. In step 320, the disable sent to the second BIOS ROM 120 is inverted to the enable signal by the inverter 150 and sent to the second BIOS ROM 120. The second BIOS ROM 120 would be at the enable state to boot the system 100.

Step 330 determines if the baseboard management controller 140 received the expiration signal provided from the timer 160 in a predetermined time. If the baseboard management controller 140 did not receive the expiration signal, namely, the second BIOS ROM 120 has erased the timer 160 repeatedly, and the system 100 would be regarded as started up normally.

However, if the baseboard management controller 140 received the expiration signal in step 330, the start-up process has failed. Then, in step 340 the output setting of the I/O pin of the baseboard management controller 140 is changed, thus the output signal of the I/O pin would become an enable signal after the system 100 is restarted.

Then, in step 350 the system 100 restarts after the baseboard management controller 140 receives the expiration signal. The setting of the output signal of the I/O pin of the baseboard management controller 140 has been changed in step 340, and the output signal becomes the enable signal in step 360. The enable signal is sent to the first BIOS ROM 110 directly, and the first BIOS ROM 110 is at the enable state for booting the system 100 in step 370. The timer 160 is erased after the system 100 is restarted successfully.

The enable signal sent to the second BIOS ROM 120 is inverted to the disable signal by the inverter 150, and the disable signal is sent to the second BIOS ROM 120. The second BIOS ROM 120 is at the disable state and would not operate.

The timer in the system generates the expiration signal to the baseboard management controller when the system is failed to start up. The system for auto-operating the backup firmware and the method thereof may switch to the backup BIOS ROM by the inverter and the baseboard management controller after the system is restarted.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A system for auto-operating backup firmware comprising:
a baseboard management controller having an I/O pin;
a first BIOS ROM electrically connected to the I/O pin of the baseboard management controller;
an inverter electrically connected to the I/O pin of the baseboard management controller; and
a second BIOS ROM electrically connected to the inverter.

2. The system for auto-operating backup firmware of claim 1, further comprising a timer electrically connected to the baseboard management controller.

3. The system for auto-operating backup firmware of claim 2, wherein the timer is electrically connected to the first BIOS ROM and the second BIOS ROM.

4. The system for auto-operating backup firmware of claim 2, wherein the timer is a watchdog timer.

5. The system for auto-operating backup firmware of claim 1, further comprising a central processing unit electrically to the first BIOS ROM and the second BIOS ROM respectively.

6. A method for auto-operating backup firmware comprising:
outputting an enable signal from a baseboard management controller in a system;
sending the enable signal to a first BIOS ROM;
inverting the enable signal to a disable signal and sending to a second BIOS ROM;
determining if the baseboard management controller has received an expiration signal provided from a timer in a predetermined time;
changing an output setting of the baseboard management controller when the baseboard management controller received the expiration signal;
restarting the system;
outputting the disable signal from the baseboard management controller;
sending the disable signal to the first BIOS ROM; and
inverting the disable signal to the enable signal and sending to the second BIOS ROM.

7. The method for auto-operating backup firmware of claim 6, further comprising booting the system by the second BIOS ROM.

8. The method for auto-operating backup firmware of claim 7, further comprising erasing the timer after the system is restarted.

9. The method for auto-operating backup firmware of claim 6, wherein the disable signal is inverted by an inverter.

10. A method for auto-operating backup firmware comprising:
sending a disable signal from a baseboard management controller in a system;
inverting the disable signal to a enable signal and sending to a first BIOS ROM;
determining if the baseboard management controller has received an expiration signal provided from a timer in a predetermined time;
changing an output setting of the baseboard management controller when the baseboard management controller received the expiration signal;
restarting the system; and
sending the enable signal to a second BIOS ROM form the baseboard management controller.

11. The method for auto-operating backup firmware of claim 10, further comprising booting the system by the second BIOS ROM.

12. The method for auto-operating backup firmware of claim 11, further comprising erasing the timer after the system is restarted.

13. The method for auto-operating backup firmware of claim 10, wherein the disable signal is inverted by an inverter.
